(19) United States
(12) Patent Application Publication
(10) Pub. No.: US 2019/0234512 A1
(43) Pub. Date: Aug. 1, 2019

(54) CIRCUIT HOUSING FOR RECEIVING A PORTION OF A SELECTOR LEVER FOR A VEHICLE, AND CIRCUIT ASSEMBLY

(71) Applicant: ZF Friedrichshafen AG, Friedrichshafen (DE)

(72) Inventor: Alex Hessel, Lemförde (DE)

(73) Assignee: ZF Friedrichshafen AG, Friedrichshafen (DE)

(21) Appl. No.: 16/341,839

(22) PCT Filed: Sep. 13, 2017
(86) PCT No.: PCT/EP2017/073013

§ 371 Date: Apr. 12, 2019

(30) Foreign Application Priority Data
Oct. 13, 2016 (DE) DE102016219925.0

(51) Int. Cl. F16H 59/02; B60K 20/08

(52) U.S. Cl. CPC F16H 59/0278; F16H 2059/026; B60K 20/08

(57) ABSTRACT

A circuit housing for receiving a section of a selector lever for a vehicle may include a base part with at least one base retaining element. The circuit housing may additionally include a cover part for closing the base part, where the cover part has at least one cover retaining element configured for latching to the base retaining element to secure the cover part to the base part without screws.

### RELATED APPLICATIONS

This application is a filing under 35 U.S.C. § 371 of International Patent Application PCT/EP2017/073013, filed Sep. 13, 2017, and claiming priority to German Patent Application 10 2016 219925.0, filed Oct. 13, 2016. All applications listed in this paragraph are hereby incorporated by reference in their entireties.

### TECHNICAL FIELD

The present invention relates to a circuit housing for receiving a section of a selector lever for a vehicle and a gearshift module.

### BACKGROUND

The housing parts of a circuit housing for a vehicle can normally be screwed together.

Based on this, the present invention creates an improved circuit housing and an improved gearshift module.

### BRIEF DESCRIPTION OF THE DRAWINGS

FIG. 1 shows a schematic illustration of a circuit housing according to one embodiment;

FIG. 2 shows a schematic illustration of the circuit housing in FIG. 1, in the assembled state.

FIG. 3 shows a schematic illustration of the circuit housing in FIG. 2 and a vehicle console.

FIG. 4 shows a schematic illustration of the circuit housing in FIG. 2 and a vehicle console.

FIG. 5 shows a schematic illustration of the circuit housing in FIG. 2 and a vehicle console.

FIG. 6 shows a schematic illustration of a gearshift module according to an exemplary embodiment.

### DETAILED DESCRIPTION

A circuit housing for receiving a section of a selector lever for a vehicle is presented, wherein the circuit housing has the following features:
a base part with at least one base retaining element; and
a cover part for closing the base part, wherein the cover part has at least one cover retaining element that can latch to the base retaining element, in order to be able to secure the cover part to the base part without screws.

The circuit housing can be a housing for receiving an electronic or mechanical shifting gate for shifting gears in the vehicle transmission. When the selector lever is a program selector lever, the shifting gate can alternatively be used for selecting a program for controlling the vehicle, e.g. for controlling the drive unit of the vehicle. In this case, an end section of the selector lever can be moveably supported in the shifting gate or in the cover part. The shifting gate can have mechanisms or sensors for detecting a setting or movement of the selector lever. The shifting gate can be screwed, for example, to a vehicle console. In particular, the circuit housing can be comprised of numerous molded plastic components. A base part can be a shell-like part of the circuit housing. The base part can be molded to accommodate the shifting gate. A cover part can be a plate or likewise shell-like part for covering the base part. A base retaining element and cover retaining element can be elements that can be latched together without tools. In the installed state of the circuit housing, the base retaining element and the cover retaining element are secured to one another in a force or form fitting manner, or in a force and form fitting manner. By way of example, one of the retaining elements can be in the form of an eyelet, and the other retaining element can be in the form of a latching lug.

The approach described herein is based on the knowledge that the housing parts of a multi-part circuit housing for a vehicle transmission can be secured to one another using appropriate retaining elements. This has the advantage that the circuit housing can be assembled without screws and corresponding tools, such that the assembly time and production costs can be reduced.

According to one embodiment, the cover retaining element is an eyelet. The base retaining element can then be a latching lug that hooks into the eyelet. An eyelet can be a U-shaped clamp with two legs and a crosspiece connecting the two legs. The crosspiece can function as a stop for the base retaining element. By way of example, the cover retaining element in the shape of the eyelet can protrude downward from the cover part. In particular, the cover retaining element can protrude downward from the cover part, perpendicular to a main plane of extension of the cover part. As a result, a robust retention between the cover part and base part can be ensured.

According to another embodiment, the base retaining element can be the eyelet. In this case, the cover retaining element can be a latching lug that hooks into the eyelet. This embodiment also results in a robust retention between the cover part and the base part.

It is also advantageous when the cover retaining element protrudes downward from the cover part in a direction transverse, e.g. perpendicular, to a main plane of extension of the cover part. Additionally or alternatively, the base retaining element can protrude from the base part in a direction transverse, e.g. perpendicular, to a main plane of extension of the base part. A main plane of extension can be the plane of the cover part or base part with the greatest expansion. As a result, the joining of the cover part and base part is simplified.

The base part can have at least one further base retaining element according to another embodiment. The cover part can then also have at least one further cover retaining element that interacts with the further base retaining element. As a result, the cover part can be securely attached to the base part.

The base part can be rectangular, for example. Additionally or alternatively, the cover part can also be rectangular. The base retaining element and the further base retaining element can then be located on opposite sides of the base part. Accordingly, the cover retaining element and the further cover retaining element can be located on opposite sides of the cover part. As a result, the cover part can be secured to the base part with just two pairs of retaining elements, and thus in a particularly simple manner.

According to another embodiment, the base part can have at least one base projection with a through hole through which a screw can be inserted. The cover part can have at least one cover projection with a through hole through which the screw can be inserted. The through hole in the base projection and the through hole in the cover projection can lie opposite one another when the cover part is secured to the base part. Depending on the embodiment, the base part can also have numerous base projections, e.g. at least four base projections. Accordingly, the cover part can have as many projections as the base part. By way of example, the base and cover projections can each be located at respective corners of the base or cover parts. As a result, the circuit housing in a vehicle can be screwed together with the fewest possible number of screws. In this manner, the assembly effort is reduced.

It is advantageous when the base projection forms a stop for installing the circuit housing in a vehicle console. In this manner, installing the circuit housing is further simplified.

According to another embodiment, the cover part can have a selector lever hole through which the selector lever can extend. As a result, the selector lever can be easily inserted into the circuit housing after the circuit housing has been installed in the vehicle.

It is also advantageous when the base part, or additionally or alternatively the cover part, is formed as a molded plastic component. As a result, the circuit housing can be produced in widely varying shapes with relatively low production costs.

The approach presented herein ultimately results in a gearshift module with the following features:
a selector lever;
a shifting gate; and
a circuit housing according to any of the preceding embodiments, wherein the shifting gate is located in the base part, a section of the selector lever is inserted through the selector lever hole in the cover part, and an end section of the selector lever can move in the shifting gate.

A gearshift module of this type offers the advantage of a particularly simple and quick installation. The gearshift module can be used to control various functions in a vehicle. By way of example, the gearshift module can be used for shifting gears in a vehicle transmission, or to control a drive or an information system in the vehicle.

In the following description of preferred exemplary embodiments of the present invention, the same or similar reference symbols are used for the elements shown in the various figures having similar functions, wherein there shall be no repetition of the descriptions of these elements.

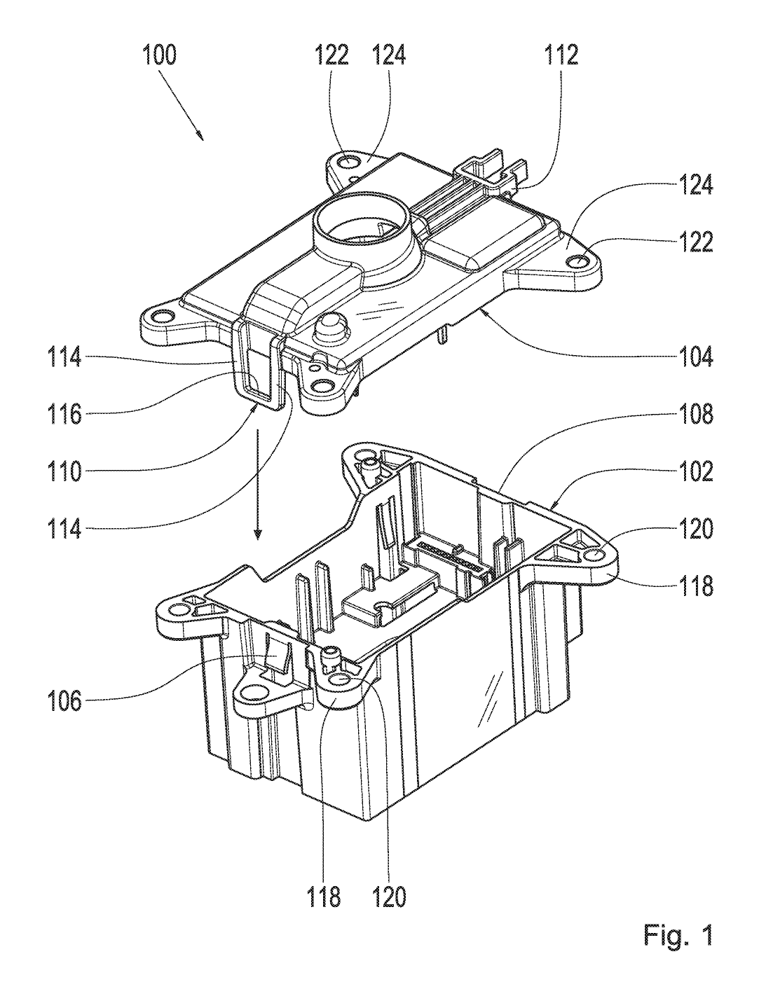

FIG. 1 shows a schematic illustration of a circuit housing 100 according to an exemplary embodiment, in this case in the unassembled state. The circuit housing 100 comprises a shell-like base part 102 and a plate-shaped cover part 104 for closing the base part 102. The base part 102 has a base retaining element 106 and a further base retaining element 108 in this exemplary embodiment. The base part 102 is rectangular, by way of example, wherein the two base retaining elements 106, 108 are each located in the middle of a narrow side of the base part 102, and are thus opposite one another. Analogously, the cover part 104 has a cover retaining element 110 that can latch to the base retaining element 106 and a further cover retaining element 112 that can latch to the further base retaining element 108. Like the base part 102, the cover part 104 is also rectangular, wherein the two cover retaining elements 110, 112 are likewise located in the middle of a respective narrow side of the cover part 104. The cover part 102 can be attached without screws to the base part 104 by means of the four retaining elements 105, 108, 110, 112.

Depending on the embodiment, the base part 102 can have more than two base retaining elements and the cover part 104 can have more than two cover retaining elements.

According to the exemplary embodiment shown in FIG. 1, the two cover retaining elements 110, 112 are each formed as a U-shaped clamp or eyelet with two legs 114 and a crosspiece connecting the two legs 114. The two cover retaining elements 110, 112 each extend substantially perpendicular to a main plane of extension of the cover part 104, away from the cover part 104 in the assembly direction. The assembly direction is indicated with a vertical arrow. The two base retaining elements 106, 108 are each formed as latching lugs, which hook into the crosspiece 116 when the circuit housing 100 is assembled. The latching lugs are connected to a side wall of the base part 102 in the form of an elastic latch, protruding slightly away from the side wall at an angle.

According to an alternative exemplary embodiment, the base retaining elements 106, 108 can be clamps or eyelets, and the cover retaining elements 110, 112 can be latching lugs.

By way of example, the base part 102 according to FIG. 1 has four base projections 118. The four base projections 118 each have a through hole 120 through which a screw can be inserted. According to FIG. 1, the four base projections 118 are each located on a corner of the base part 102 facing cover part 104. Analogously, the cover part 104 also has four cover projections 122, each of which has a through hole 124 through which a screw can be inserted. The cover projections 122 are located on the cover part 104 such that when the circuit housing 100 is assembled, each of the cover projections 122 is aligned with one of the base projections 118, wherein the respective through holes 120, 124 are flush with one another.

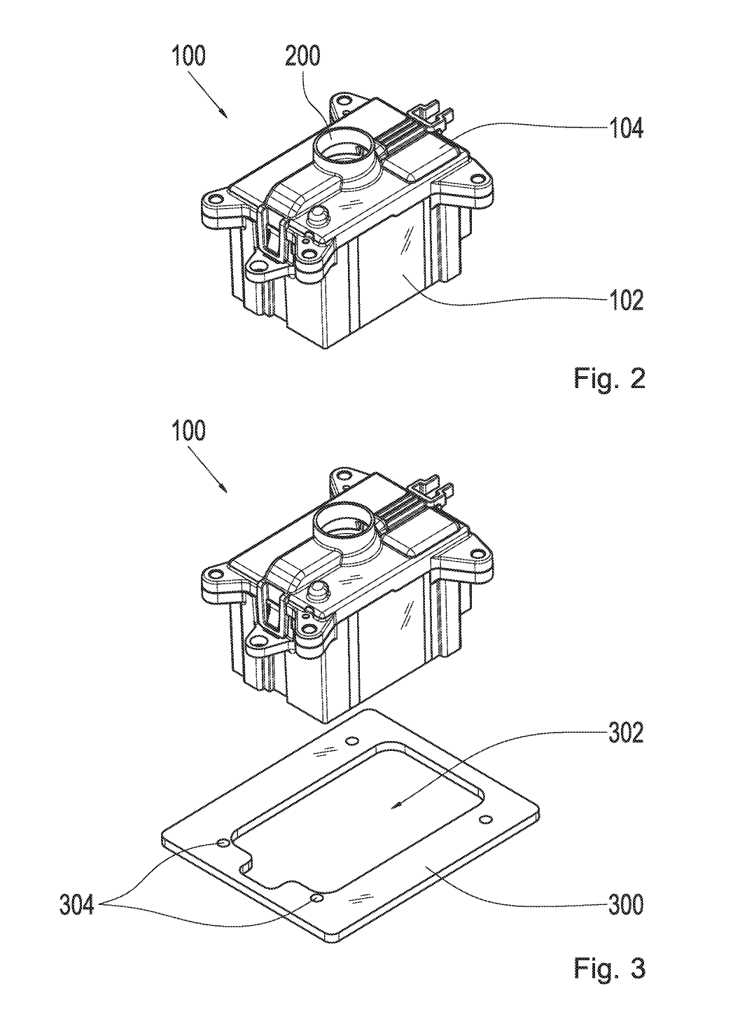

FIG. 2 shows a schematic illustration of the circuit housing 100 in FIG. 1, in the assembled state. As can be seen in FIG. 2, the cover part 104 according to this exemplary embodiment has a selector lever hole 200 through which a section of a selector lever, e.g. a gearshift lever or a program selector lever, can be inserted. The selector lever can be actuated by a driver of a vehicle. By way of example, the selector lever hole 200 is located substantially in the middle of the cover part 104.

FIG. 3 shows a schematic illustration of the circuit housing 100 in FIG. 2, and a vehicle console 300. The vehicle console is the part of a vehicle, for example, in which the circuit housing 100 is to be installed. The vehicle console 300, in this case a simple plate, comprises a cut-out 302 for the circuit housing 100, and four screw holes 304, by way of example, through which screws can be inserted or screwed.

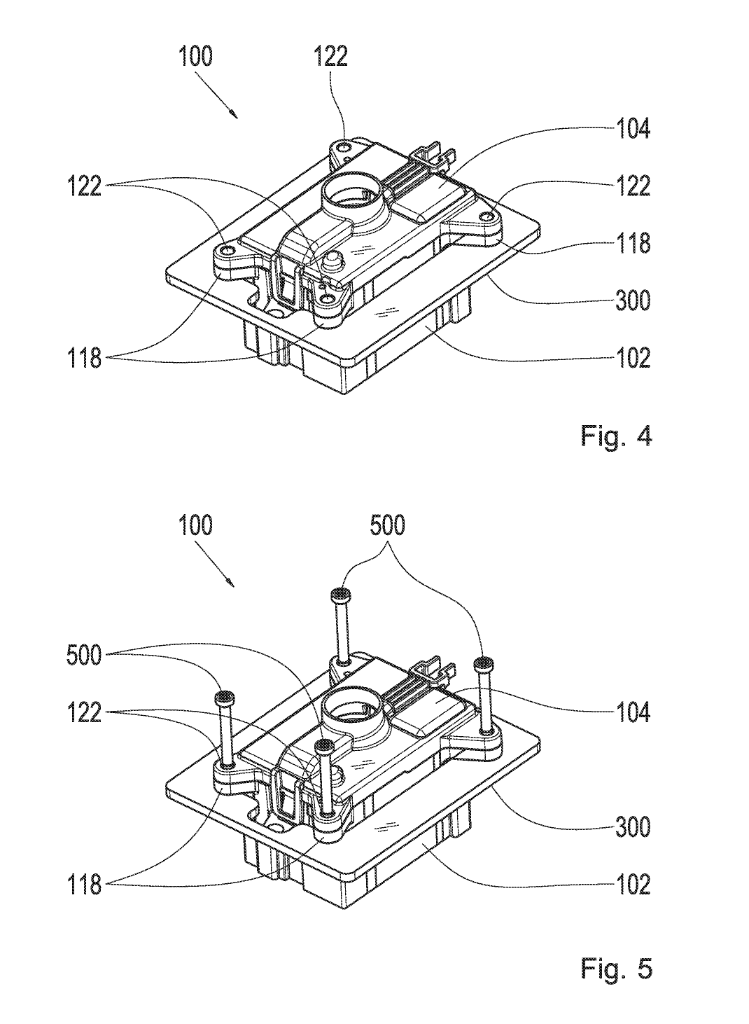

FIG. 4 shows a schematic illustration of the circuit housing 100 in FIG. 2, and a vehicle console 300. In differing from FIG. 3, FIG. 4 shows the circuit housing 100 and the vehicle console 300 in the assembled state. The circuit housing 100 is partially inserted into the cut-out, wherein the base projections 118 of the base part 102 function as stops, and the respective through holes in the base projections 118 and the cover projections 122 are aligned with the screw holes in the vehicle console 300.

FIG. 5 shows a schematic illustration of the circuit housing 100 in FIG. 2 and a vehicle console 300. As in FIG. 4, the circuit housing 100 and the vehicle console 300 are shown in FIG. 5 in the assembled state. In addition, four screws 500 for screwing the circuit housing 100 to the vehicle console 300 by means of the projections 118, 122 are shown. By way of example, the housing parts 102, 104 are first fully joined together by the screws 500 when the circuit housing 100 is installed in the vehicle.

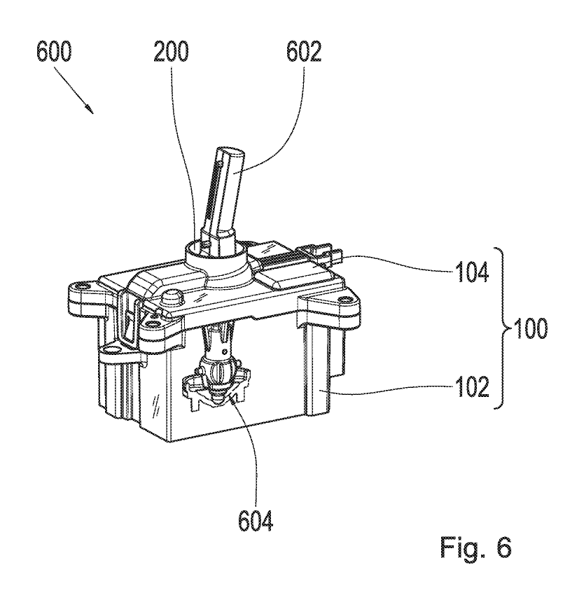

FIG. 6 shows a schematic illustration of a gearshift module 600 according to an exemplary embodiment. The gearshift module 600 comprises the circuit housing 100, composed of a circuit housing, such as that described above based on the FIGS. 1 to 5, a selector lever 602, which is inserted into the circuit housing 100 through the selector lever hole 200 in the cover part 104, and a shifting gate 604 located in the base part 102. The shifting gate 604 can be a shifting gate 604 that can be mechanically actuated by the selector lever 602, or it can be a shifting gate 604 that is configured to detect a position or movement of the selector lever 602 electronically, by means of an appropriate sensor system, and to output a control signal that represents the position or movement. For this, an end section of the selector lever 602 is located in the shifting gate 604 such that it can move therein. The selector lever 602 is used according to one exemplary embodiment for selecting a gear in the vehicle transmission, which can be an automatic transmission in particular, or for selecting a driving program for the vehicle. According to one exemplary embodiment, the selector lever 602 is supported in the selector lever hole 200 such that it can swivel or pivot.

If an exemplary embodiment comprises an “and/or” conjunction between a first feature and a second feature, this can be read to mean that the exemplary embodiment contains both the first feature and the second feature according to one embodiment, and contains either just the first feature or just the second feature according to another embodiment.

### REFERENCE SYMBOLS

100 circuit housing
102 base part
104 cover part
106 base retaining element
108 further base retaining element
110 cover retaining element
112 further cover retaining element
114 leg
116 crosspiece
118 base projection
120 through hole in a base projection
122 through hole in a cover projection
124 cover projection
200 selector lever hole
300 vehicle console
302 cut-out
304 screw hole
500 screw
600 gearshift module
602 selector lever
604 shifting gate

1. A circuit housing for receiving a section of a selector lever for a vehicle, wherein the circuit housing comprises:
a base part with at least one base retaining element; and
a cover part for closing the base part, wherein the cover part has at least one cover retaining element configured for latching to the base retaining element to secure the cover part to the base part without screws.

2. The circuit housing according to claim 1, wherein the cover retaining element includes an eyelet, and wherein the base retaining element includes a latching lug that can be hooked to the eyelet.

3. The circuit housing according to claim 1, wherein the cover retaining element protrudes away from the cover part, transverse to a main plane of extension of the cover part.

4. The circuit housing according to claim 1, wherein the base part has a second base retaining element and the cover part has a second cover retaining element that can be latched to the second base retaining part.

5. The circuit housing according to claim 4, wherein at least one of the base part and the cover part is rectangular, wherein the base retaining element and the second base retaining element are located on opposite sides of the base part, and wherein the cover retaining element and the second cover retaining element are located on opposite sides of the cover part.

6. The circuit housing according to claim 1, wherein the base part has at least one base projection with a through hole for receiving a screw, wherein the cover part has at least one cover projection with a through hole for receiving the screw, and wherein the through hole of the base projection and the through hole of the cover projection are opposite one another when the cover part is secured to the base part.

7. The circuit housing according to claim 6, wherein the base projection forms a stop for positioning the circuit housing in a vehicle console.

8. The circuit housing according to claim 1, wherein the base part is formed as a molded plastic component.

9. The circuit housing according to claim 1, wherein the cover part has a selector lever hole for receiving the selector lever.

10. A gearshift module comprising:
a selector lever;
a shifting gate; and
the circuit housing according to claim 9, wherein the shifting gate is located in the base part, wherein a portion of the selector lever is inserted through the selector lever hole in the cover part, and wherein an end section of the selector lever can move in the shifting gate.

11. The circuit housing according to claim 1, wherein the base retaining element protrudes away from the base part, transverse to the main plane of extension of the base part.

12. The circuit housing according to claim 1, wherein the cover part is formed as a molded plastic component.

13. A method, comprising:
forming a circuit housing for receiving a section of a selector lever for a vehicle, wherein the circuit housing comprises:
a base part with at least one base retaining element; and
a cover part for closing the base part,
wherein the cover part has at least one cover retaining element configured for latching to the base retaining element to secure the cover part to the base part without screws.

14. The method according to claim 13, wherein the cover retaining element includes an eyelet, and wherein the base retaining element includes a latching lug that can be hooked to the eyelet.

15. The method according to claim 13, wherein the cover retaining element protrudes away from the cover part, transverse to a main plane of extension of the cover part.

16. The method according to claim 13, wherein the base part has a second base retaining element and the cover part has a second cover retaining element that can be latched to the second base retaining part.

17. The method according to claim 16, wherein at least one of the base part and the cover part is rectangular, wherein the base retaining element and the second base retaining element are located on opposite sides of the base part, and wherein the cover retaining element and the second cover retaining element are located on opposite sides of the cover part.

18. The method according to claim 13, wherein the base part has at least one base projection with a through hole for receiving a screw, wherein the cover part has at least one cover projection with a through hole for receiving the screw, and wherein the through hole of the base projection and the through hole of the cover projection are opposite one another when the cover part is secured to the base part.

19. The method according to claim 18, wherein the base projection forms a stop for positioning the circuit housing in a vehicle console.

20. The method according to claim 13, wherein the base part is formed as a molded plastic component.
